(19) United States
(12) Patent Application Publication
(10) Pub. No.: US 2017/0349055 A1
(43) Pub. Date: Dec. 7, 2017

(54) APPARATUS AND METHOD FOR ELECTRICALLY CONNECTING A CHARGING STATION TO A CHARGING SOCKET OF A VEHICLE

(71) Applicant: Robert Bosch GmbH, Stuttgart (DE)

(72) Inventor: Ahmet Kilic, Boeblingen (DE)

(21) Appl. No.: 15/537,546

(22) PCT Filed: Oct. 15, 2015
(86) PCT No.: PCT/EP2015/073913

§ 371 Date: Jun. 19, 2017

(30) Foreign Application Priority Data
Dec. 22, 2014 (DE) 10 2014 226 755.2

(51) Int. Cl. B60L 11/18; H01R 13/631

(52) U.S. Cl. CPC B60L 11/1835; H01R 13/6315; B60L 2230/10; B60L 2230/16

(57) ABSTRACT

The present invention provides an apparatus and a method for electrically connecting a charging station to the charging socket of a vehicle. To this end, a contact head which is connected to a voltage source is positioned in front of a charging socket of a vehicle and then inserted into the charging socket. In order to ensure the contact head is securely and reliably oriented during insertion into the charging socket, the contact head has adjustment means in this case, said adjustment means automatically orienting the contact head during insertion into the charging socket. In this way, the requirements for positioning the contact head before insertion can be reduced and the security of the vehicle which is to be charged making contact with the charging station can be increased.

### BACKGROUND OF THE INVENTION

The present invention relates to an apparatus and a method for electrically connecting a charging station to a charging socket of a vehicle and a charging station comprising such an apparatus.

The German patent publication DE 10 2009 001 080 A1 discloses a charging apparatus for a land-based motor vehicle comprising a battery-like current storage apparatus. An electrical connection can be produced between the current storage apparatus and a charging apparatus via a contact arm. The contact arm is thereby attached to the charging apparatus in a movable manner.

Inductive and conductive charging methods are known for charging the traction batteries in electric and hybrid vehicles. The inductive charging methods are based on a combination of a transmitter coil having a receiving coil system. On the other hand, conductive charging procedures require the insertion of a charging cable between a charging station and the electric or hybrid vehicle. The ease and comfort for charging the electrical energy store plays a decisive role for the acceptance of future electric and hybrid vehicles.

There is therefore the need for an apparatus and a method for the automatic electrical connection of a charging station to the charging socket of an electric or hybrid vehicle, which enable a comfortable, reliable and efficient connection of the charging station to the charging socket of the vehicle.

### SUMMARY OF THE INVENTION

To this end, the present invention provides an apparatus for electrically connecting a charging station to a charging socket of a vehicle according to a first aspect. The apparatus comprises a contact head which is electrically connected to a voltage source of the charging station. Furthermore, the apparatus comprises an insertion apparatus for electrically connecting the charging station to a charging socket, said insertion apparatus being designed to insert the contact head into the charging socket of the vehicle. The contact head has adjustment means in this case which are designed to automatically orient the contact head during the insertion into the charging socket.

According to a further aspect, the present invention provides a method for electrically connecting a charging station to a charging socket of a vehicle. The method comprises the steps of providing a contact head which is electrically connected to a voltage source of the charging station; of positioning the contact heat at a predetermined position with respect to the charging socket of the vehicle; of inserting the contact head into the charging socket of the vehicle; and of automatically orienting the contact head during the insertion of the contact head into the charging socket by means of adjustment means at the contact head.

Conductive charging methods enable a relatively low-loss transmission of large amounts of energy. As a result, the present invention is based on the insight that, for an automatic connection between charging station and the charging socket of an energy store to be charged, such as, for example, a traction battery of an electric or hybrid vehicle, it is very difficult to fully automatically insert a plug into the charging socket. It is difficult to practically impossible for a driver of such a vehicle to always precisely park the vehicle at a predetermined position such that the charging socket on the vehicle is situated in each case exactly at the same spatial position with respect to the charging station. If, however, the position of the charging socket of an electric or hybrid vehicle varies with respect to the charging station, it is thus impossible for existing, conventional systems to automatically produce a reliable connection between charging station and charging socket of the vehicle without additional sensor technology.

The concept underlying the invention is therefore to enable a simple but nevertheless secure and reliable contacting of the charging station to the charging socket of the vehicle even when the position of a charging socket in relation to the charging station varies. To this end, a rough positioning of a contact head, such as, for example, a plug of a charging cable or something similar, is initially carried out by means of a positioning apparatus. The positioning apparatus is designed to position the contact head at a predetermined position in relation to the charging socket of the vehicle. In so doing, the contact head of the charging apparatus is designed according to the present invention in such a way that a fine adjustment of the contact head takes place automatically during the insertion of the contact head into the charging socket of a vehicle. The contact head is thus automatically oriented during the insertion into the charging socket such that a secure and reliable contacting of the contacts of the charging socket to the contacts of the contact head takes place.

Due to the particular design of the contact head, said contact head can automatically orient itself within a predetermined tolerance range. A highly precise orientation of the contact head already during the positioning by the positioning apparatus is therefore not required. A complex and expensive sensor technology for precisely determining the position of the charging socket on the vehicle can thus be eliminated. The elimination of such a sensor technology simplifies the structure of an automatic charging station. The complexity of the charging station is therefore reduced. The charging station is therefore less subject to errors. Furthermore, such a charging station can also be implemented significantly more cost effectively.

Because the apparatus according to the invention for electrically connecting the charging station to a charging socket does not place any high demands on the exactness of the position of a charging socket on the vehicle, the vehicle too does not have to be very precisely parked at an exactly predetermined position at the charging station. The parking of the vehicle for charging at an automatic charging station can thus be carried out as a normal parking procedure manually by the user. An additional support by further technical auxiliary means for a precise parking of the vehicle at an exactly predetermined position is not necessarily required.

According to one embodiment, the position apparatus is designed to position the contact head within a predetermined spatial tolerance range in relation to the charging socket of the vehicle. A rough positioning of the contact head in the proximity of the charging socket is sufficient for the automatic connecting of the charging station to the charging socket of the vehicle. The charging head should thereby be oriented such that said charging head can be inserted into the charging socket of the vehicle by a simple movement in the direction of said charging socket in a subsequent step. Due to the design of the contact head, no high demands are placed on the exactness for the positioning of the contact head. The tolerance range in which the contact head has to be positioned at the charging socket of the vehicle can therefore be relatively generously selected. For example, the contact head can deviate in a range of approximately 5 cm, 10 cm or 15 cm from the optimal positioning of the contact head. That means, the rough positioning by the positioning apparatus can position the contact head such that said contact head can deviate perpendicularly from a line, which results from the movement direction of an optimally positioned charging head during the insertion into the charging socket, by the size mentioned above.

According to a further embodiment, the contact head comprises a compensation element. The compensation element is designed to adjust a movement of the contact head during the insertion into the charging socket. This movement of the contact head during the insertion into the charging socket takes place, for example, by means of lateral movements of the contact head due to the fine adjustment during the insertion into the charging socket. By means of a flexible compensation element that can give way in the case of a force effect on the contact head, said contact head can optimally orient itself in relation to the charging socket.

According to a special embodiment, the compensation element comprises a joint, in particular a joint that automatically returns to its initial position, a spring element and/or an elastomer.

According to a further embodiment, the adjustment means comprises a rotation device. Such a rotation device can be designed to rotate the contact head about a predetermined axis. The predetermined axis can particularly relate to an axis which results from the direction in which the contact head is moved during the insertion into the charging socket. By means of such a rotation device, the contact head can at least be approximately oriented such that the contacts of the contact head are correspondingly aligned with the contacts in the charging socket. To this end, the rotation device can actively carry out a rotating process by means of a drive.

Alternatively, a rotation device is also possible without a discrete drive, which enables a rotation of the contact head due to external forces.

According to a further embodiment, the adjustment means comprises recesses, which extend into the interior of the contact head and thereby taper in the direction of the interior of the contact head. A particularly simple and efficient orientation of the contact head can be achieved during the insertion into the charging socket by means of such recesses that are reduced inwardly in diameter or respectively width.

According to a further embodiment, the adjustment means comprises a ball wheel, a roller, a track, a pin, a groove and/or further guide elements. A particularly simple orientation of the contact head during the insertion into the charging socket can be achieved by such guide elements.

According to one embodiment, the contact head has a rotationally symmetrical outside geometry. The contact head can particularly have a conical outside geometry. Rotationally symmetrical forms place particularly small demand on the orientation and are thus suitable for an automatic insertion into the charging socket.

According to one embodiment, the contact head has a non-rotationally symmetrical arrangement of contacts. Such non-rotationally symmetrical arrangements of contacts lead to a clear allocation of the contacts between contact head and charging socket. The individual contacts of the charging head do not have to be completely designed as circles. In so doing, a large number of contacts can also be disposed on a contact head having a relatively small surface area.

According to a further embodiment, the apparatus comprises a communication device. The communication device is designed to receive data from the vehicle. Furthermore, the communication device can also be designed to send data to the vehicle. Information that is relevant for the charging process can be obtained from the vehicle to be charged by means of such a communication device. The position of the charging socket on the vehicle can, for example, be transmitted. Moreover, charging parameters, such as voltage, maximum admissible current strength, battery capacity, the amount of energy to be transferred, authorization parameters or account data can also be transmitted. In this way, the charging process for the electric vehicle can be optimally prepared and carried out.

According to a further embodiment, the positioning apparatus comprises a first positioning device and a second positioning device. The first positioning device is designed to the move the contact head in a vertical spatial direction. The second positioning device is designed to move the contact head in a spatial direction that is orthogonal to the first movement direction of the first positioning device. The contact head can initially be roughly adjusted to the position of the charging socket on the vehicle to be charged by such a movement of the contact head by means of a biaxial positioning apparatus.

According to a further embodiment, the method for electrically connecting the charging station to a charging socket of the vehicle comprises a step for determining the predetermined position for the positioning of the contact head in relation to the contact socket of the vehicle. By the individual determination of the position at which the contact head is to be roughly positioned, the positioning for different types of vehicles, or if need be for each individual vehicle, can be individually adapted. A great deal of flexibility is thus possible when connecting the charging station to a vehicle to be charged.

According to a further embodiment, the method comprises a step for releasing the charging socket of the vehicle before the contact head is inserted in said charging socket. The releasing of the charging socket can, for example, be folding the charging socket out of a park position. Thus, the charging socket can be protected from dirt or other environmental influences prior to charging.

According to a further aspect, the present invention provides a charging station comprising an apparatus according to the invention for electrically connecting the charging station to a charging socket of a vehicle.

### BRIEF DESCRIPTION OF THE DRAWINGS

Further embodiments and advantages of the present invention ensue from the following description with reference to the attached drawings.

In the drawings:

FIG. 1 shows a schematic depiction of a top view of an apparatus for electrically connecting a charging station to a charging socket according to one embodiment;

FIG. 2 shows a schematic depiction of a side view of an apparatus for electrically connecting a charging station to a charging socket according to a further embodiment;

FIG. 3 shows schematic depictions for the interaction of a contact head with a contact socket according to one embodiment;

b FIGS. 4a and 4b show schematic depictions for the interaction of a contact head with a contact socket according to further embodiments;

FIGS. 5a through 5d show schematic depictions of a contact head of an apparatus for electrically connecting a charging station to a charging socket according to further embodiments;

FIG. 6 shows a schematic depiction for the interaction of a charging head with a charging socket of a vehicle according to still another embodiment; and

FIG. 7 shows a schematic depiction of a flow diagram as it underlies a method according to a further embodiment.

### DETAILED DESCRIPTION

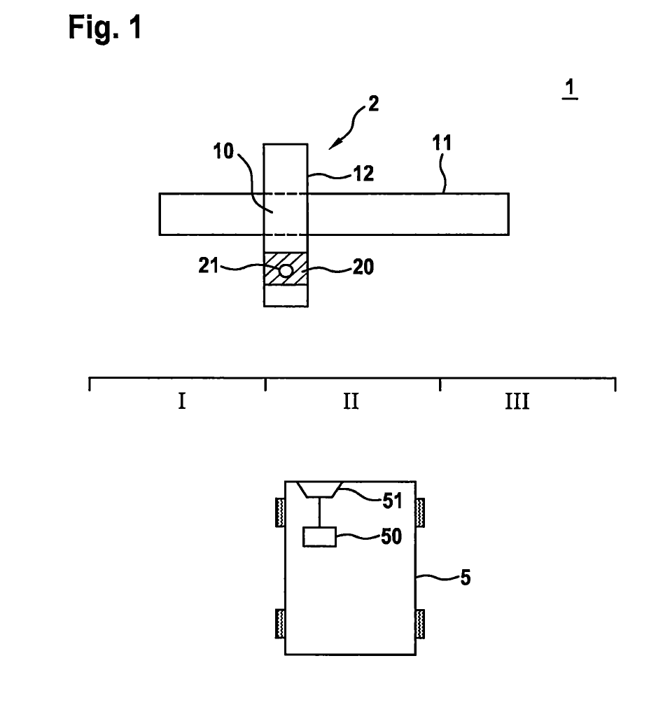

FIG. 1 shows a schematic depiction of a charging station 1 comprising an apparatus 2 for electrically connecting the charging station 1 to a charging socket 51 of a vehicle 5. The vehicle 5 can, for example, relate to as hybrid or electric vehicle. The vehicle 5 can, particularly relate to a completely or partially electrically driven motor vehicle, for example to a passenger car (PKW) or to a truck (LKW). The charging station comprises a positioning apparatus 10 and an insertion apparatus 20 comprising a contact head 21. The insertion apparatus 20 and thus also the contact head 21 disposed on the insertion apparatus 20 are moved along predetermined directions. Hence, the contact head 21 can be positioned at a predetermined position in relation to the charging socket 51 of the vehicle 50. The positioning apparatus can, for example, have a first positioning device 11 and a second positioning device 12. The first positioning device 11 can, for example, carry out a horizontal movement and thus move the insertion apparatus 20 comprising the contact head 21 horizontally, i.e. parallel or at least approximately parallel to a parking area for the vehicle. The second positioning device 12 can be mechanically connected to the first positioning device 11 and carry out a movement in a vertical spatial direction. The movement direction of the second positioning device 12 is thus perpendicular to the movement direction of the first positioning device 11. In this way, the insertion apparatus 20 comprising the contact head 21 can for example be moved laterally by the first positioning device 11. As a result, a plurality of vehicles 5 parked next to one another can be energized. Three vehicles 5 can, for example, be parked next to one another on the three parking areas I, II and III. Said three vehicles can be energized with respect to the degree of freedom of the positioning apparatus by the lateral movement of the insertion apparatus 20 comprising the contact head 21 by means of the first positioning device 11 of the positioning apparatus 10. Furthermore, the contact head 21 of the insertion apparatus 20 can also thereby be brought to a position which correlates to the position of the charging socket 51 of the corresponding vehicle 5. The height of the charging socket 51 as well as the height of the contact head 21 are initially not taken into account during this positioning. The positioning of the contact head 21 at the same or at least approximately the same height as the height of the charging socket 51 of the corresponding vehicle 5 takes place separately by means of the second positioning device 12.

The horizontal and vertical orientation of the contact head 21 in relation to the charging socket 51 does not have to exactly correlate to the position of the charging socket 51 of the corresponding vehicle 5 during the positioning by the positioning apparatus 10. In fact, it is sufficient to position the contact head 21 within a predetermined tolerance range in relation to the charging socket 51 of the vehicle 5. The exact orientation of the charging head 21 in relation to the charging socket 51 takes place in this case during the insertion of the contact head 21 into the charging socket 51 and is explained in greater detail below.

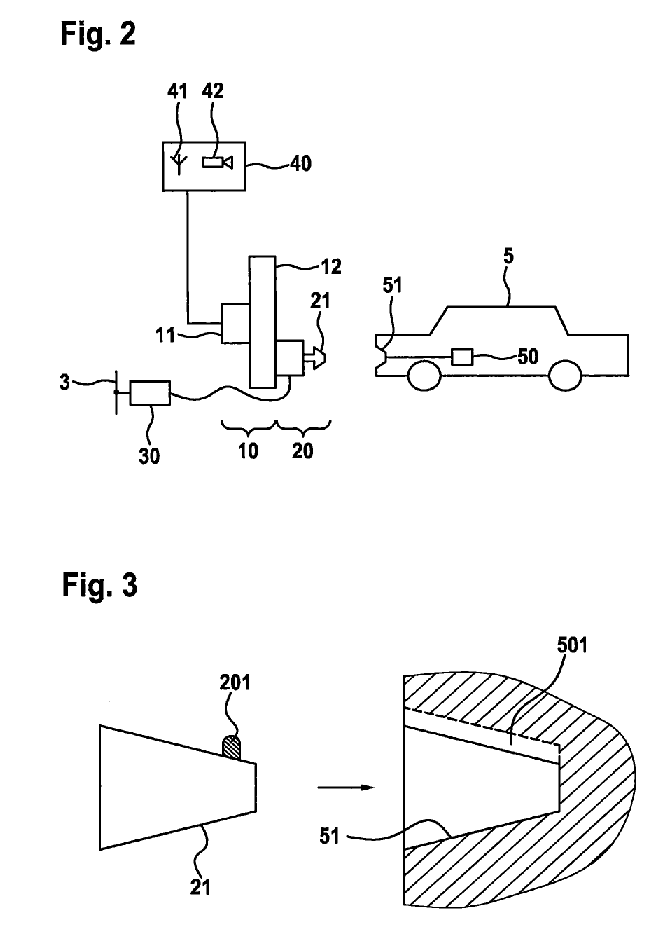

FIG. 2 shows a schematic depiction of a lateral view of a charging station 1 comprising an apparatus 2 for electrically connecting the charging station 1 to a charging socket 51 of a vehicle according to one embodiment. The apparatus 2 can in this case comprise a communication device 40, which receives data from the vehicle. The data transmission can thereby take place in one direction from the vehicle 5 in the direction of the communication device 40. Alternatively, a bidirectional data transmission between vehicle 5 and communication device 40 is also possible. The communication device 40 can, for example, comprise a radio interface 41. A wireless data transmission between communication device 40 and vehicle is possible by means of this radio interface 41. For example, the radio interface 41 can establish a WLAN connection to the vehicle 5. Alternatively, a connection via a mobile communications network is also possible, for example GSM, UMTS or LTE. Furthermore, a wireless data exchange by means of near field communication (NFC/RFID) can also take place. Further wireless communication methods are furthermore likewise possible. Additionally or alternatively, the communication device 40 can also comprise an optical sensor 42 or an optical interface. The optical sensor 42 can, for example, relate to a camera, a barcode scanner or a QR-code scanner. Further apparatuses for receiving data from the vehicle 5 or respectively for data exchange between vehicle 5 and apparatus 2 for automatic connection are furthermore likewise possible.

The communication device 40 can receive vehicle-specific data from the vehicle 5, in particular data that are relevant for the charging of the energy store 50 in the vehicle 5. These data can, for example, include authorization data, account parameters, charging voltage, charging current, battery capacity and further charging parameters. Furthermore, information about the position of the charging socket 51 on the vehicle 5 can also be contained in the transmitted data. In addition, the communication device 40 can also receive data about the parked position of the vehicle 5 in relation to the charging station 1. The GPS coordinates can, for example, be transmitted from the vehicle 5 to the communication device 40. It is also possible that the communication device 40 detects the position of the vehicle 5 in relation to the charging station 1 by means of suitable sensors. The position of the vehicle 5 can, for example, be detected by means of a camera 42, an ultrasonic sensor, radar sensor or another kind of sensor.

The contact head 21 on the insertion apparatus 20 of the apparatus 2 for automatically connecting the charging station 1 to the charging socket 51 of a vehicle 5 can comprise a plurality of electrical contacts. These electrical contacts are electrically connected to a voltage source 30. The voltage source 30 can, for example, relate to a voltage converter or respectively a charging controller, which adapts electrical energy provided by an energy supply network 3 or another external energy source for the charging of the energy store 50 in the vehicle 5. Alternatively, it also possible that the contacts of the contact head 21 are directly connected to an energy supply network 3 or another voltage source. In this case, it is only required that the electrical connection between the energy supply network 3 or the further voltage source on the one side and the contacts of the contact head 21 on the other side can be closed or respectively opened by means of suitable switching elements in order to start or end the charging process. In this case, the adaptation of current and voltage for the charging of the energy store 50 in the vehicle takes place by means of a charging controller in the vehicle 5.

In order to charge the energy store 50 of a vehicle 5, the contact head 21 has to be inserted in the charging socket 51 of the vehicle. In so doing, the contacts of the contact head 21 are electrically connected to the contacts of the charging socket 51. In this way, an electrical connection is established between the voltage source 39 and the vehicle 5. Subsequently, the energy store 50 of the vehicle 5 can be charged. After completing the charging process, the voltage supply between charging station 1 and vehicle 5 is interrupted and the contact head 21 is again removed from the charging socket 51.

For an automatic charging process, the insertion of the contact head 21 into the charging socket 51 of the vehicle also has to take place automatically. To this end, the apparatus 2 for electrically connecting the charging station 1 to the charging socket 51 of the vehicle initially positions the insertion apparatus 20 comprising the charging head 21 in front of the charging socket. For this purpose, the apparatus 2 determines the horizontal and vertical position of the charging socket 51. Subsequently, the insertion apparatus 20 comprising the charging head 21 is positioned in front of the charging socket 51. The vehicle should thereby be parked at the charging station such that the charging socket 51 is oriented in the direction of the apparatus 2 for connecting the charging station 1 to the charging socket 51. In the process, no high demands are placed on the accuracy of the positioning of the insertion apparatus 20 comprising the contact head 21. In fact, it is sufficient that the charging head 21 is situated in a predetermined tolerance range in front of the charging socket 21. The charging head 21 can, for example, in this case deviate in a range with deviations of 5, 10, 15 cm or more from the optimal position. This optimal position is seen as a position in which the contact head 21 can be inserted straight into the charging socket 51.

After the charging head 21 has been positioned within a predetermined tolerance range in front of the charging socket 51, the contact head 21 is subsequently inserted into the charging socket 51 by means of the insertion apparatus 20. To this end, the contact head 21 is moved in the direction of the charging socket 51 by means of the insertion device 20. Charging head 21 and charging socket 51 are designed in such a way that an automatic orientation of the contact head 21 occurs during the insertion of the charging head 21 into the charging socket 51. For this purpose, the contact head 21 can have adjustment means which automatically orient the contact head 21 during the insertion into the charging socket 51. The contact head 21 can thereby be rotated, tilted or canted or varied in another way so that the contacts of the contact head 21 are oriented corresponding to the contacts of the charging socket 51.

In order to insert the contact head 21 into the charging socket 51, the insertion apparatus 20 can have means which move the contact head 21 towards the charging socket 51. The insertion apparatus 20 can, for example, have a scissors mechanism. Alternatively, other mechanical apparatuses are possible which move the contact head 21 into the charging socket 51 by means of an electric drive, hydraulics or pneumatics.

The insertion apparatus 20 can furthermore have a rotation device 23. The contact head 21 can be rotated about a predetermined rotational axis by means of this rotation device 23. This rotational axis can, for example, run parallel to a direction in which the contact head 21 moves into the charging socket 51 during the insertion. The rotation device 23 can be directly disposed on the contact head 21. By rotating the contact head 21 by means of the rotation device 23, the contacts of the contact head 21 are oriented in relation to the contacts of the charging socket of the vehicle 5. The rotation of the contact head 21 by means of the rotation device 23 can, for example, be adjusted based on predetermined parameters, which result from the data that have been transmitted from the vehicle 5 to the communication device 40. Alternatively, a sensor technology (not depicted here) can also be disposed on the contact heat 21 of the insertion apparatus 20 or at another point on the apparatus for connecting the charging station to the charging socket in order to detect the orientation of the contacts of the charging socket 51 on the vehicle 5. The contact head 21 can subsequently be oriented corresponding to the orientation of the contacts on the charging socket 51. The rotation of the contact head 21 as well as the insertion of the contact head 21 into the charging socket 51 can likewise be determined based on predetermined parameters which result from the data received by the communication device 40. The contact head 21 can be actively rotated into the desired position by means of a drive in the rotation device 23. Alternatively, it is also possible that the rotation device 23 relates to a rotational joint which enables a rotational movement by means of the influence of external forces.

The insertion apparatus 20 can furthermore comprise a compensation element 24. This compensation element 24 enables a lateral movement of the contact head 21 during the insertion of said contact head 21 into the charging socket 53. Such a compensation element 24 particularly enables the contact head 21 to be able to carry out a movement during the insertion of said contact head 21 into the charging socket 51, said movement being perpendicular or at least approximately perpendicular in relation to the movement direction of said contact head 21 during the insertion of said contact head 21 in the charging socket. This compensation element 24 can, for example, relate to a spring element, a joint with a predetermined restoring force, a partial piece made of elastomer or something similar. The compensation element can, for example, enable a movement of the contact head 21 if the force exerted on said contact head 21 exceeds a predetermined limit value. If a force is exerted on the compensation element 24 is below a predetermined limit value, the compensation element 24 then remains at least approximately stiff. If, on the other hand, the force exerted exceeds a predetermined limit value, the compensation element 24 gives way and thus allows for a deviation in the movement direction exerted by means of the insertion apparatus 20 during the insertion of the contact head 21 into the charging socket 51.

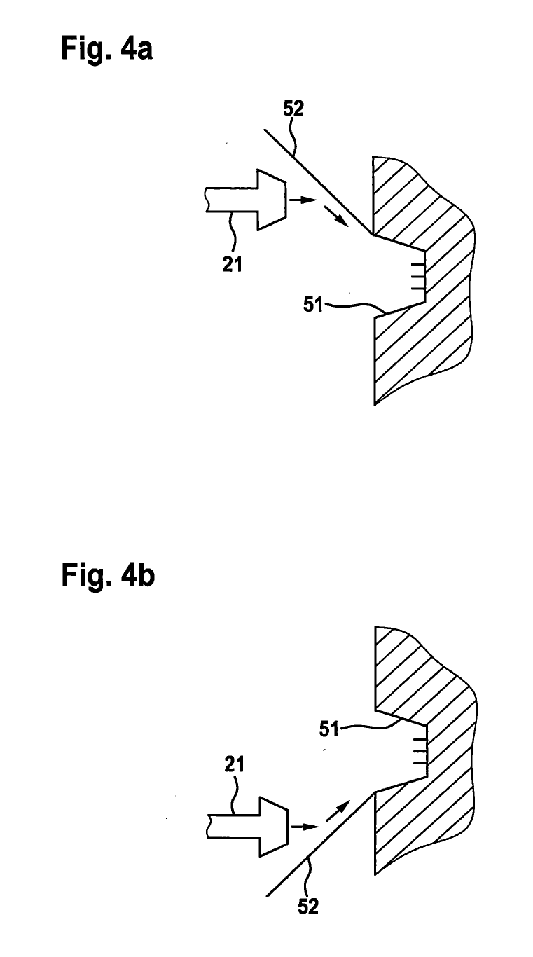

FIG. 3 shows a schematic depiction of a cross-section through a contact head 21 and a corresponding charging socket 51. The contact head 21 has adjustment means 201. These adjustment means 201 can relate to a roller, a ball wheel, a pin or another raised portion. Furthermore, a recess, for example a groove or something similar, is possible as adjustment means 201. A corresponding guide 501 that corresponds to the adjustment means 201 of the contact head 21 is incorporated on the charging socket 51 of the vehicle. When inserting the contact head 21 into the charging socket 51, the contact head 21 can thus be oriented in relation to the charging socket 51 by means of the interaction of the adjustment means 201 with the corresponding guide 501 in the charging socket. In this way, it is possible to orient the contacts of the contact head 21 such that said contacts are appropriately connected to the contacts of the charging socket 51. In order to improve the sliding properties during insertion of the contact head 21 into the charging socket 51, the surface of the contact head 21 and/or the surface of the charging socket 51 can be coated with a lubricating material. To this end, a coating consisting of polytetrafluorethylene (PTFE) or something similar is, for example, suitable.

FIGS. 4a and 4b show schematic depictions for the insertion of a contact head 21 into a contact socket 51 of a vehicle 5. In order to facilitate the insertion process of the contact head 21 into the charging socket 51, a guide element 52 is disposed in front of the charging socket 51 in the embodiment depicted in FIG. 4a. The guide element 52 can, for example, relate to a plate, a track, a rod or an arrangement of a plurality of rods or something similar. In particular, it is also possible that the guide device 52 relates to a covering in front of the charging socket 51, which is opened towards the outside before inserting the charging head 21. If the contact head 21 approached the charging socket 51 during the insertion process into said charging socket 51 and in doing so hits on the guide 52, the contact head 21 can be guided along the guide 52 in the direction of the charging socket 51. Thus, possibly existing horizontal or vertical deviations in the positioning of the contact head 21 in relation to the charging socket 51 can be automatically corrected. It is particularly possible that an adjustment means 201 disposed on the contact head 21 is guided by the guide 52 such that the contact head 21 is properly oriented in relation to the charging socket 51. In this case, it is also possible that the contact head 21 executes a rotational movement. Hence, the contacts of the contact head 21 are correctly oriented in relation to the contacts of the charging socket 51.

FIG. 4b shows an alternative embodiment for a charging socket 51 comprising as guide 52. In this embodiment, the guide is disposed beneath the charging socket 51. For example, this can also relate to a covering of the charging socket 51 which is opened downwards prior to inserting the contact head 21; however, other embodiments for a guide 52 are also possible. Analogous to FIG. 4a, the contact head can also in this case be guided along the guide 52 during the insertion into the charging socket 51 and in so doing an automatic orientation of the contact head 21 occurs. In this case, adjustment means 201 on the charging head can interact with the guide 52 on the charging socket in order to facilitate an orientation of the contact head 21.

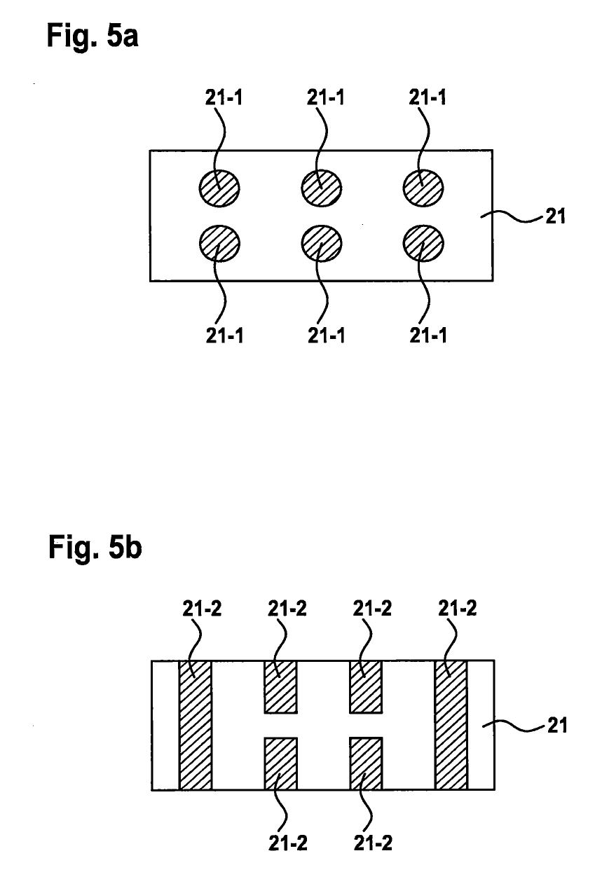

By way of example, FIGS. 5a to 5d show in each case a top view of a contact head 21. In FIG. 5a, the contact head 21 comprises a plurality of funnel-shaped recesses 21-1. An electrical contact of the contact head 21 can be disposed in each case in these funnel-shaped recesses 21-1. In principle, recesses without electrical contacts are also possible. Such recesses can serve to improve the guiding process during the insertion of the contact head 21 into the charging socket 51. By means of the funnel-shaped configuration, in which the diameter of the recess is continually reduced in the direction of the interior of the contact head 21, the plug still can be reliably inserted into the charging socket 51 and an electrical contacting of the contacts of the contact head 21 can take place with contacts of the charging socket 51 even when small deviations exist during the positioning of the contact head 21 in relation to the charging socket 51 of a vehicle 5 to be charged. The funnel-shaped configuration of the recesses allows in this case an automatic orientation of the contact head 21 in relation to the charging socket 21.

FIG. 5b shows a further top view of an embodiment of a contact head 21. In this case, the contact head 21 has a plurality of slot-shaped recesses 21-2. The slot-shaped recesses 21 can thereby have a v-shaped form. In so doing, the width of the gap 21-2 is reduced as seen in the direction of the interior of the contact head 21. In this way, it is also possible that the contact head 21 automatically orients itself within predetermined tolerances during insertion into a charging socket 51 of a vehicle 5 to be charged. The gap-shaped recesses 212 can either extend along a direction on the surface of the contact head 21; or the gaps 21-2 can alternatively also extend only over a portion, such as in the center of the contact head 21 in FIG. 5b so that a plurality of gaps arise along a direction on the surface of the contact head 21. An electric contact can in each case be disposed in the interior of the gap 21-2. In this and the following embodiments, recesses without electrical contacts are also possible.

The FIGS. 5c and 5d show circular contact heads 21. In FIG. 5c, the contact head 21 has circular recesses 21-3 in which respectively one electrical contact can be disposed. A particularly simple insertion of the contact head 21 into a charging socket 51 of a vehicle can occur by means of such rotationally symmetrical contact heads 21. In this case, a rotation of the contact head 21 in order to orient the contacts does not have to take place.

FIG. 5d likewise shows a circular contact head 21, in which the recesses 21-4 in the contact head 21 are however configured as circular segments. In this way, a plurality of contacts can be disposed within a circular circumference. Hence, a large number of contacts can be achieved in a small space. In order to force a distinct orientation in a circular contact head 21, as said contact head is depicted, for example, in FIG. 5d, the individual circular sectors can be configured in different sizes. As a result, the width of the recesses 21-4 as well as the size of the circular segment can vary. In this way, it can be ensured that a circular contact head 21 can be inserted into the charging socket 51 of a vehicle only in a predetermined orientation.

The number of recesses and contacts depicted in connection with the FIGS. 5a to 5d is used only to improve the understanding of the invention and does not represent a limitation of the present invention. A number of contacts that deviates from the depicted number is likewise possible. The rectangular contact heads depicted in the FIGS. 5a and 5b are also to be understood only in an exemplary manner. Geometries deviating therefrom, such as, for example, square forms, polygons etc. are likewise possible.

The contact heads 21 preferably have a conical or cone-shaped or respectively truncated cone-shaped outside geometry. In so doing, the base area, on which the contacts or respectively the recesses for the contacts are disposed, has a smaller base area in comparison to the side comprising the insertion apparatus 20. In other words, the contact head 21 tapers in the direction of the surface on which the contacts or respectively the recesses for the contacts are disposed. In this way, an automatic orientation of the contact head 21 upon insertion into the charging socket 51 is possible within predetermined tolerances.

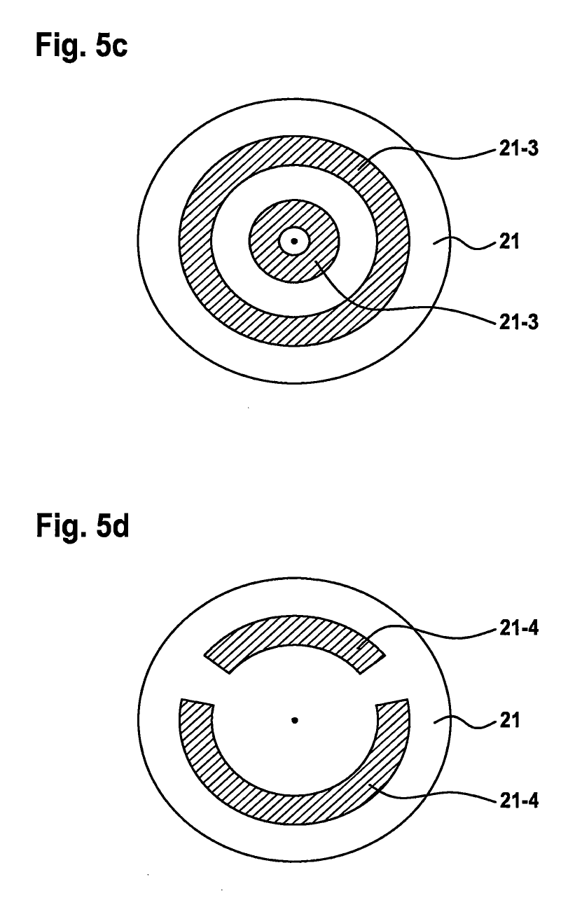

FIG. 6 shows a schematic depiction of a cross-section through a contact head 21 and a corresponding charging socket 51 of a vehicle 5. In order to contact the contact head 21 with the charging socket 51, the contact head 21 is inserted in the arrow direction towards the charging socket 51. The charging socket 51 has three contacts 51-a, 51-b and 51-c in this example. The contact head 21 has correspondingly three recesses comprising the contacts 21-a, 21-b and 21-c. Whereas, in this example, the three contacts 51-a, 51-b and 51-c of the charging socket 51 are configured equally long, the three contacts 21-a, 21-b and 21-c of the contact head 21 are at different distances away from the outside of charging socket 51 that faces in the direction of the charging socket 51. In this way, it can be achieved that the contacts 21-a, 21-b and 21-c of the contact head 21 can be electrically contacted to the corresponding contacts 51-a, 51-b and 51c of the charging socket 51 upon insertion of the contact head 21 into the charging socket 51. Hence, it can, for example, be ensured that initially an electrical contacting of a reference potential occurs. First after the reference potential of the contact head 21 is connected via the corresponding contact to the charging socket and thus to the vehicle to be charged, the contacting of the phase connections, via which the energy feed during the charging of the energy store 50 in the vehicle 5 is to take place, subsequently takes place upon the contact head 21 being further inserted into the charging socket 51. After these contacts are also electrically connected to one another, the contacting of a data connection required for the communication during the charging process can finally occur, via which data connection the charging process is then first enabled. In this way, the safety during the contacting can be increased and possibly existing safety requirements can be fulfilled.

In addition to the exemplary embodiment depicted here, in which the contacts 51-a, 51-b and 51-c of the charging socket 51 are equally long and the contacts 21-a, 21-b and 21-c of the contact head 21 are disposed at different positions in relation to the distance to the outside of the contact head 21 which faces the charging socket 51, it is also alternatively possible to dispose a charging socket 51 having contacts 51-a, 51-b and 51-c of different lengths in the vehicle and to dispose the contacts 21-a, 21-b and 21-c of the contact head 21 at an equal distance from the outside which faces the charging socket 51.

The previously described apparatus 2 of a charging station 1 for automatically electrically connecting the charging station 1 to the charging socket 51 of a vehicle 5 allows for a great deal of flexibility when connecting between the charging station 1 and the vehicle 5. In particular, variations in the position of a charging socket 51 on different vehicles 5 can already be taken into account by means of the positioning apparatus 10; and in each case, an appropriate position for the insertion of the contact head 21 into the charging socket 51 can be homed in on. The automatic fine adjustment of the contact head 21 during the insertion into the charging socket 51 makes it possible to place only small demands on the accuracy of the positioning apparatus 10. In addition, a plurality of vehicles 5 parked next to one another can be consecutively serviced by one and the same charging station 1 by means of a large action radius of the positioning apparatus 10. To this end, the contact head 21 can consecutively be inserted in each case into one of the charging sockets 51 of a plurality of vehicles 5 parked next to one another, and the corresponding energy store 50 of the respective vehicle is charged. After the energy store 50 is completely charged or the any discontinuation criteria have been fulfilled, the contact head 21 can again be removed from the respective charging socket 51 and subsequently inserted in the charging socket 51 of the next vehicle. The energy store 50 of the next vehicle 5 can subsequently be charged. In this way, flexible charging concepts for the charging of a plurality of vehicles by means of one charging station are possible. Data transmitted from the vehicle 5 to the communication device 40 can also be taken into account when creating the charging concepts. Optimal charging concepts can thus in each case be calculated and carried out for a plurality of vehicles at one charging station 5. For example, the energy stores 50 of a plurality of vehicles 5 can in each case be initially only partially charged. After all energy stores 50 have in each case a predetermined minimum charge level, the energy stores 50 of the vehicles can subsequently be further consecutively charged. Hence, it can be ensured that all vehicles are initially in good running order, and the cruising range of the vehicles can subsequently be increased by further charging. Further flexible charging concepts are furthermore likewise possible. By means of the automatic contacting and de-contacting of the vehicles 5, a manual user intervention is not necessary for the charging of a plurality of electric vehicles by means of a single charging station 1. In so doing, the comfort as well as the safety can be increased during the charging process.

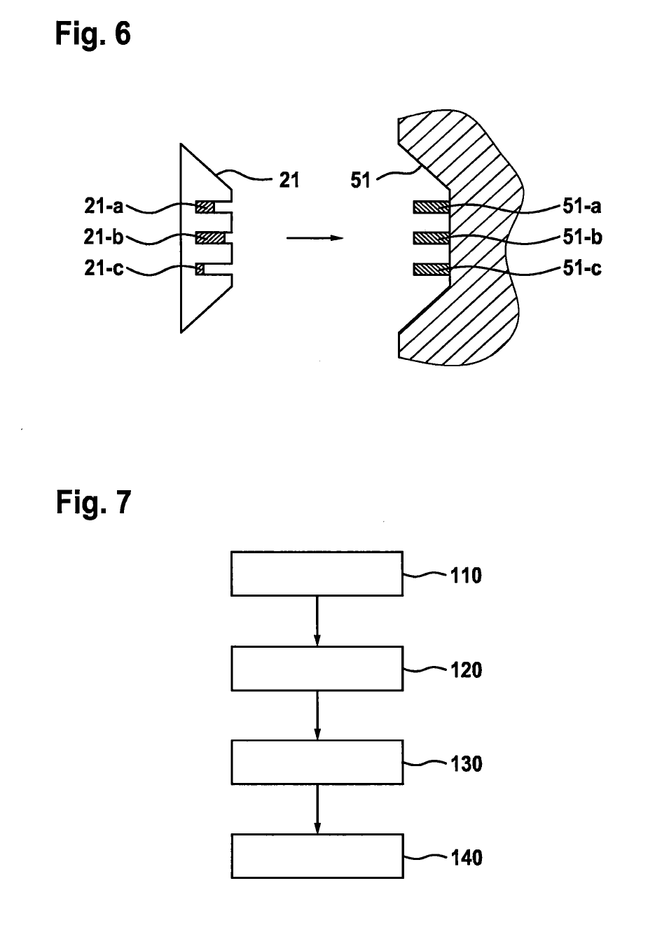

FIG. 7 shows a schematic depiction of a flow diagram as said diagram underlies a method for electrically connecting a charging station 1 to a charging socket 51 of a vehicle 5. In Step 110, a contact head 21 is initially provided. This contact head 21 and particularly the contacts of this contact head 21 can be electrically connected to a voltage source 30 of the charging station 1. The contact head 21 can particularly be disposed on an insertion apparatus 20, as said apparatus has been previously described. In Step 120, the contact head 21 is subsequently positioned at a predetermined position in relation to the charging socket 51 of the vehicle 5. This predetermined position relates to a position in front of the charging socket 51, from which an insertion of the charging head 21 into the charging socket 51 is possible. This predetermined position can particularly relate to a predetermined spatial area. The dimensions of this area can comprise several centimeters up to 10 or even 20 cm. Depending on the configuration of the contact head 21 and the charging socket 51, larger spatial areas are also moreover possible.

After that, the contact head 21 is inserted into the charging socket 51 of the vehicle in Step 130. During this insertion of the contact head 21 into the charging socket 51, the contact head 21 is automatically oriented in step 150. The contact head 21 can comprise adjustment means 201, as they have previously been described, for this automatic orientation of the contact head 21 in relation to the charging socket 51.

The method can furthermore comprise a step for determining the predetermined position for the positioning of the contact head in relation to the charging socket for a flexible connection of the charging station 1 to the charging socket 51 of a vehicle 5. Data from the vehicle 5 can particularly be received and evaluated for such a step. These data can either directly specify the position of the charging socket 51 or said data can comprise vehicle-specific data, from which the position of the charging socket 51 on the vehicle can be determined. To this end, the position of the charging socket 51 on the respective vehicle 5 can, for example, be read out of a data bank based on the received vehicle-specific data.

If the charging socket 51 of a vehicle is protected by a covering or if the charging socket 51 is, if applicable, initially folded away into the vehicle interior, such a charging socket 51 can thus be initially released in a further step by the covering being opened or the charging socket being pulled out. To this end, other means, if need be, can be disposed on the apparatus 2 for electrically connecting the charging station 1 to the charging socket 51. For example, the release of the charging socket 51 can be executed mechanically. Alternatively, an impending contact process can be signaled to the vehicle 5 by means of a radio interface of something similar, whereupon the vehicle 5 automatically releases the charging socket 51.

In summary, the present invention relates to an apparatus and a method for electrically connecting a charging station to the charging socket of a vehicle. To this end, a contact head that is connected to a voltage source is positioned in front of a charging socket of a vehicle and subsequently inserted into the charging socket. In order for the contact head to be safely and reliably oriented during the insertion into the charging socket, the contact head has adjustment means, which automatically orient the contact head during the insertion into the charging socket. In this way, the demands for the positioning of the contact head prior to insertion are reduced and the safety and reliability of the contacting of the charging station to the vehicle to be charged can be increased.

1. An apparatus (2) for electrically connecting a charging station (1) to a charging socket (51) of a vehicle (5), the apparatus comprising:
a contact head (21) which is electrically connected to a voltage source (30) of the charging station (1); and
an insertion apparatus (20) which is configured to insert the contact head (21) into the charging socket (51) of the vehicle (5);
wherein the contact head (21) has adjustment means which are configured to orient the contact head (21) during the insertion into the charging socket (51).

2. The apparatus (2) according to claim 1 comprising a positioning apparatus (10) which is configured to position the contact head (21) at a predetermined position in relation to the charging socket (51) of the vehicle (5).

3. The apparatus (2) according to claim 1, wherein the positioning apparatus (10) is configured to position the contact head (21) within a predetermined spatial tolerance range in relation to the charging socket (51) of the vehicle (5).

4. The apparatus (2) according to claim 1, wherein the contact head (21) comprises a compensation element (24) which is configured to adapt a movement of the contact head (21) during the insertion into the charging socket (51).

5. The apparatus (2) according to claim 4, wherein the compensation element (24) comprises a joint, a spring element and/or an elastomer.

6. The apparatus (2) according to claim 1, wherein the adjustment means comprises a rotation device (23) which is configured to rotate the contact head (21) about a predetermined axis.

7. The apparatus (2) according to claim 1, wherein the adjustment means comprises recesses which taper in the direction of the interior of the contact head (21).

8. The apparatus (2) according to claim 1, wherein the adjustment means have a ball wheel, a roller, a track, a pin, a groove and/or a further guide element.

9. The apparatus (2) according to claim 1, wherein the contact head (21) has a rotationally symmetrical outside geometry.

10. The apparatus (2) according to claim 1, wherein the contact head (21) has a non-rotationally symmetrical arrangement of contacts.

11. The apparatus (2) according to claim 1, wherein the apparatus further has a communication device, which is configured to receive data from the vehicle (5).

12. A charging station (1) comprising an apparatus according to claim 1 for electrically connecting the charging station (1) to a charging socket (51) of a vehicle (5).

13. A method for electrically connecting a charging station (1) to a charging socket (51) of a vehicle (5), the method comprising the following steps:
providing (110) a contact head (21), which is electrically connected to a voltage source (30) of the charging station (1);
positioning (120) the contact head (21) at a predetermined position in relation to the charging socket (51) of the vehicle (5);
inserting (130) the contact head (21) into the charging socket (51) of the vehicle (5); and
automatically orienting (140) the contact head (21) during the insertion of the contact head (21) into the charging socket (51) by means of adjustment means at the contact head (21).

14. The method according to claim 13, further comprising a step for determining the predetermined position for positioning the contact head (21) in relation to the charging socket (51) of the vehicle (5).

15. The method according to claim 13, further comprising a step for releasing the charging socket (51) of the vehicle (5) before the contact head (21) is inserted into the charging socket (51).
